(19) United States
(12) Patent Application Publication
(10) Pub. No.: US 2023/0208248 A1
(43) Pub. Date: Jun. 29, 2023

(54) MOTOR UNIT

(71) Applicant: Nidec Corporation, Kyoto (JP)

(72) Inventors: Takashi HATTORI, Kyoto (JP); Toshiya OKAMOTO, Kyoto (JP); Yoshinobu ARAO, Kyoto (JP); Daiki KATO, Kyoto (JP); Kenta SEKI, Kyoto (JP)

(21) Appl. No.: 18/084,654

(22) Filed: Dec. 20, 2022

(30) Foreign Application Priority Data
Dec. 28, 2021 (JP) 2021-214694

(51) Int. Cl. H02K 5/22; H02K 11/33

(52) U.S. Cl. CPC H02K 5/225; H02K 11/33

(57) ABSTRACT

A motor assembly includes a motor, a controller, a housing, and a seal. The housing includes a cover that covers the controller from one side in the axial direction. The cover includes a through-hole penetrating in the axial direction. The controller includes a connector portion extending through the through-hole and protruding to one side in the axial direction of the cover. The seal seals an area between an inner edge of the through-hole and the connector portion. An obverse surface on one side in the axial direction of the cover includes a groove portion recessed to the other side in the axial direction. One end of the groove portion communicates with the through-hole.

### CROSS-REFERENCE TO RELATED APPLICATIONS

The present application claims priority under 35 U.S.C. § 119 to Japanese Patent Application No. 2021-214694, filed on Dec. 28, 2021, the entire contents of which are hereby incorporated herein by reference.

### 1. FIELD OF THE INVENTION

The present invention relates to a motor assembly.

### 2. BACKGROUND

A conventional motor assembly includes a housing. The housing includes a housing body and a cover. The housing body accommodates the motor. The cover closes the opening of the housing body.

A through-hole may be formed in the cover of the housing in order to pull out the connector portion connected to the external terminal to the outside. In the configuration in which the through-hole is formed in the cover, moisture may enter the housing through the through-hole.

### SUMMARY

A motor assembly according to an example embodiment of the present invention includes a motor including a rotor rotatable about a central axis and a stator radially opposing the rotor, a controller to control the motor, a housing to accommodate the motor and the controller, and a seal. The housing includes a cover to cover the controller from one side in an axial direction. The cover includes a through-hole penetrating in the axial direction. The controller includes a connector portion extending through the through-hole and protruding to the one side in the axial direction of the cover. The seal seals an area between the inner edge of the through-hole and the connector portion. An obverse surface on the one side in the axial direction of the cover includes a groove portion recessed toward another side in the axial direction. One end of the groove portion communicates with the through-hole.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an exploded perspective view of a motor assembly according to an example embodiment of the present disclosure.

FIG. 2 is a plan view of a housing body according to an example embodiment of the present disclosure.

FIG. 3 is a perspective view of a cover according to an example embodiment of the present disclosure as viewed from below.

FIG. 4 is a cross-sectional view schematically illustrating a seal structure between the cover, the housing body, and a connector portion according to an example embodiment of the present disclosure.

FIG. 5 is a perspective view of a cover according to an example embodiment of the present disclosure as viewed from above.

FIG. 6 is a plan view of the cover according to an example embodiment of the present disclosure as viewed from above.

FIG. 7 is a cross-sectional view schematically illustrating the shape of an outer edge portion of a cover according to a first modification of an example embodiment of the present disclosure.

FIG. 8 is a plan view of a cover according to a second modification of an example embodiment of the present disclosure as viewed from above.

### DETAILED DESCRIPTION

Hereinafter, example embodiments of the present invention will be described with reference to the accompanying drawings.

In the present specification, a direction in which a central axis CA of a motor 1 extends is referred to as an “axial direction”, and one side and the other side in the axial direction are respectively defined as an upper side and a lower side. However, the definitions of upper and lower sides do not limit the orientation and positional relationship when a motor assembly 100 is used.

In addition, in the present specification, a radial direction centered on the central axis CA is simply referred to as a “radial direction”, a direction approaching the central axis CA in the radial direction is simply referred to as a “radially inside”, and a direction away from the central axis CA is simply referred to as a “radially outside”. A circumferential direction centered on the central axis CA is simply referred to as a “circumferential direction”.

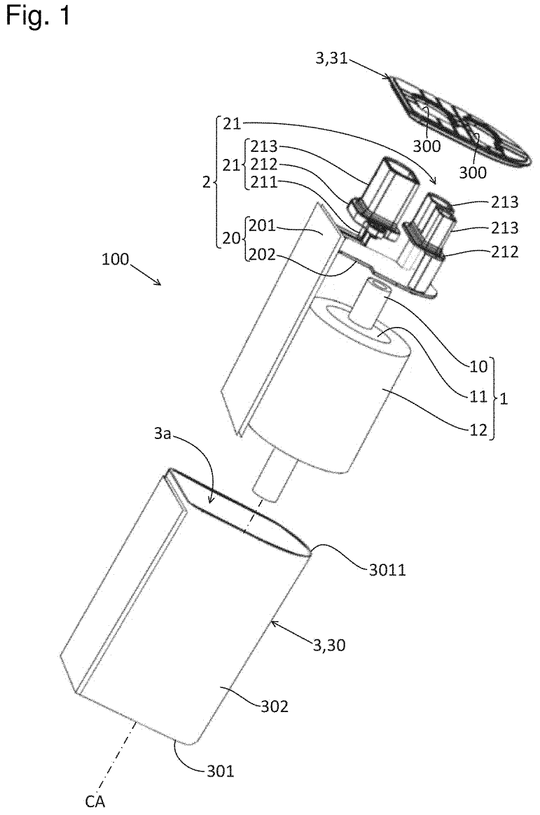

FIG. 1 is an exploded perspective view of the motor assembly 100 according to the example embodiment.

The motor assembly 100 according to the present example embodiment includes the motor 1, a controller 2, and a housing 3. The housing 3 accommodates the motor 1 and the controller 2.

The motor 1 includes a rotor 11 and a stator 12. The rotor 11 is rotatable about the central axis CA. The stator 12 radially faces the rotor 11. More specifically, the stator 12 is disposed radially outside the rotor 11. The stator 12 rotationally drives the rotor 11. The motor 1 includes a shaft 10. The shaft 10 extends in the axial direction along the central axis CA. The shaft 10 is rotatably supported by a bearing (not illustrated). The shaft 10 forms the rotation shaft of the motor 1.

The rotor 11 includes a rotor core and a rotor magnet (reference numerals are omitted). The rotor core has a cylindrical shape extending in the axial direction. The rotor core is formed by stacking a plurality of electromagnetic steel plates in the axial direction. The shaft 10 is press-fitted into the rotor core. As a result, the rotor core is rotatable together with the shaft 10. A plurality of rotor magnets are fixed to the radially outer surface of the rotor core. The plurality of rotor magnets are arranged along the circumferential direction.

The stator 12 includes a stator core, an insulator, and a coil (reference numerals are omitted). The stator core has an annular shape centered on the central axis CA. The stator core is formed by stacking a plurality of electromagnetic steel plates in the axial direction. The rotor 11 is disposed radially inside the stator core.

The insulator covers at least a portion of the stator core. The insulator is an insulating member using resin or the like. The coil is formed by winding a conductive wire around the stator core through the insulator. The coil is connected to the controller 2.

The controller 2 includes a circuit board 20 on which electronic components are mounted. The circuit board 20 includes a side board 201 and an upper board 202. The side board 201 has a surface facing the radial direction as a mounting surface and is disposed radially outside the motor 1. The upper board 202 has a surface facing the axial direction as a mounting surface and is disposed on the upper side of the motor 1. However, the present invention is not limited to this. The components mounted on one of the side board 201 and the upper board 202 may be mounted on the other, and the one board may be omitted. Further, either a plurality of side boards 201 or a plurality of upper boards 202 may be provided alone.

The side board 201 is connected to the coil of the stator 12. That is, the side board 201 is connected to the motor 1. The side board 201 has a drive circuit or the like that supplies drive power to the motor 1 on the mounting surface. The side board 201 supplies drive power to the stator 12.

The upper board 202 is connected to the side board 201. For example, the upper board 202 has a control device such as a microcomputer on the mounting surface. In addition, the upper board 202 has a sensor (not illustrated) for detecting the rotational position of the rotor 11 on the mounting surface. The control device on the upper board 202 controls the drive circuit on the side board 201 based on the output of the sensor. In other words, the upper board 202 controls the supply of drive power to the motor 1. In other words, the controller 2 controls the motor 1.

In addition, the controller 2 includes a connector portion 21. The connector portion 21 includes a connector pin 211 extending upward from the circuit board 20. The connector pin 211 penetrates a cover 31 to be described later and protrudes upward. In addition, the connector portion 21 includes a pin holding portion 212 that holds the connector pin 211. The connector portion 21 also has a tubular portion 213 extending in a tubular shape toward the upper side. The tubular portion 213 surrounds the connector pin 211 on the upper side of the cover 31. In other words, the tubular portion 213 penetrates the cover 31 together with the connector pin 211 and protrudes upward. In other words, the connector portion 21 penetrates the cover 31 and protrudes upward.

For example, an external terminal (not illustrated) that inputs and outputs a control signal, supply power, and the like is inserted into the tubular portion 213 and connected to the connector pin 211. The external terminal is detachable attached to the tubular portion 213.

The housing 3 includes a housing body 30. The housing body 30 has a bottomed tubular shape. More specifically, the housing body 30 has a housing bottom portion 301 and a housing tubular portion 302 extending upward from an outer edge portion of the housing bottom portion 301. The motor 1 and the controller 2 are disposed radially inside the housing tubular portion 302. That is, the housing body 30 covers the motor 1 and the controller 2 from radially outside. An upper portion (one side in the axial direction) of the housing body 30 is opened.

The housing 3 includes the cover 31. The surface of the cover 31 which faces the upper side corresponds to an “obverse surface” and is simply referred to as an “obverse surface” in the following description. A surface opposite to the obverse surface of the cover 31 corresponds to a “reverse surface” and is simply referred to as a reverse surface in the following description.

The cover 31 is a plate-like member extending in the radial direction. The cover 31 closes an opening 3a of the housing body 30 from the upper side (one side in the axial direction). That is, the cover 31 covers the controller 2 from the upper side (one side in the axial direction).

The cover 31 has a portion overlapping an upper end portion 3011 of the housing body 30 in the axial direction. That is, the cover 31 has a portion overlapping the upper end portion 3011 of the housing tubular portion 302 in the axial direction. The cover 31 overlaps the entire region of the upper end portion 3011 of the housing body 30 in the axial direction. The cover 31 is then fixed to the upper end portion 3011 of the housing body 30.

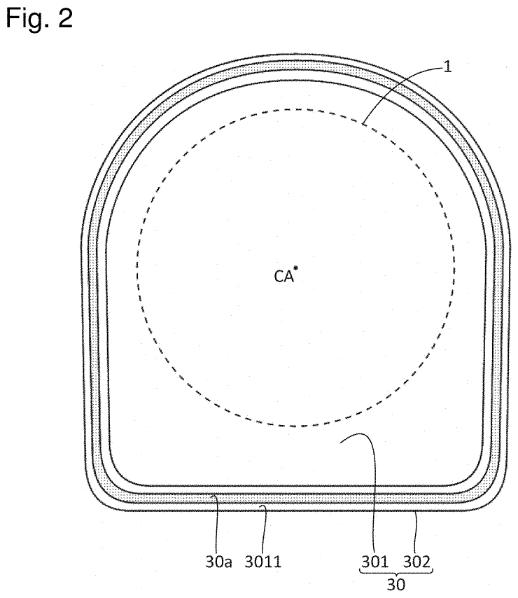

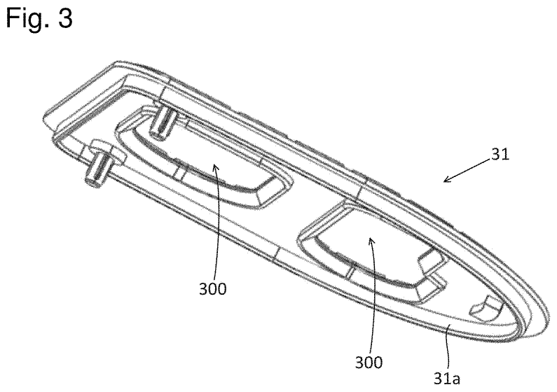

FIG. 2 is a plan view of the housing body 30 according to the example embodiment as viewed from above. Referring to FIG. 2, a dot pattern is provided at the formation position of a recess 30a to clarify the formation position of the recess 30a. FIG. 3 is a perspective view of the cover 31 according to the example embodiment as viewed from below.

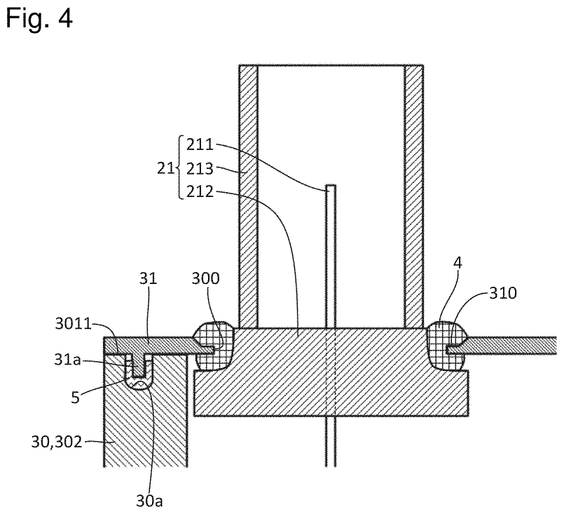

FIG. 4 is a cross-sectional view schematically illustrating a seal structure between the cover 31, the housing body 30, and the connector portion 21 according to the example embodiment. FIG. 4 illustrates a seal structure between the cover 31 and the upper end portion 3011 of the housing body 30. FIG. 4 illustrates a seal structure between a through-hole 300 of the cover 31 and the connector portion 21. Referring to FIG. 4, the vertical direction of the drawing is the axial direction, and the horizontal direction of the drawing is the radial direction.

The upper end portion 3011 which is an end portion on the upper side (one side in the axial direction) of the housing body 30 has a recess 30a recessed downward (to the other side in the axial direction). That is, the housing tubular portion 302 has the recess 30a at the upper end portion 3011. The recess 30a of the housing body 30 has a continuous annular shape when viewed from the axial direction. The reverse surface of the cover 31 has a protrusion 31a protruding downward (to the other side in the axial direction). The protrusion 31a of the cover 31 has a continuous annular shape when viewed from the axial direction. The protrusion 31a of the cover 31 overlaps the recess 30a of the housing body 30 in the axial direction over the entire area.

The protrusion 31a is disposed inside the recess 30a. Furthermore, an adhesive 5 is between the protrusion 31a and the recess 30a inside the recess 30a. As the adhesive 5, for example, a silicon-based adhesive is used. By disposing the protrusion 31a inside the recess 30a, the gap between the housing body 30 and the cover 31 meanders in a labyrinth pattern. That is, the intrusion route of moisture from the radially outside to the radially inside of the housing 3 meanders in a labyrinth pattern. This makes it possible to suppress moisture from intruding through the gap between the housing body 30 and the cover 31.

The cover 31 has the through-hole 300 penetrating in the axial direction. The connector portion 21 is drawn out from the lower side to the upper side of the cover 31 through the through-hole 300. That is, the controller 2 has the connector portion 21 extending through the through-hole 300 and protruding to the upper side (one side in the axial direction) of the cover 31.

The cover 31 has the same number of through-holes 300 as the connector portions 21. For example, the number of the connector portions 21 is two. In this example, the number of through-holes 300 is two. That is, the cover 31 has the plurality of through-holes 300. The two connector portions 21 extend through the through-holes 300 different from each other.

The motor assembly 100 includes a seal 4. The seal 4 seals between the inner edge of the through-hole 300 and the connector portion 21. This makes it possible to suppress intrusion of moisture from between the connector portion 21 and the through-hole 300. For example, a silicon-based adhesive is used as the seal 4. However, the present invention is not limited to this. An annular packing such as an O-ring may be used as the seal 4.

In this case, the obverse surface of the cover 31 has a seal placement portion 310 on the outer peripheral portion of the through-hole 300. The obverse surface of the cover 31 has the seal placement portion 310 over the entire circumference of the outer peripheral portion of the through-hole 300. That is, the seal placement portion 310 has a continuous annular shape when viewed from the axial direction and surrounds the through-hole 300. In addition, the seal placement portion 310 is recessed downward (to the other side in the axial direction).

At least a part of the seal 4 is placed on the surface of the seal placement portion 310. That is, a part of the seal 4 is bonded to the surface of the seal placement portion 310. The seal 4 extends from the seal placement portion 310 between the inner edge of the through-hole 300 and the connector portion 21. As a result, a portion of the seal 4 which is located between the inner edge of the through-hole 300 and the connector portion 21 is connected to a portion on the surface of the seal placement portion 310. This makes it easy to retain the seal 4 between the inner edge of the through-hole 300 and the connector portion 21. In other words, it is possible to suppress dripping of the seal 4.

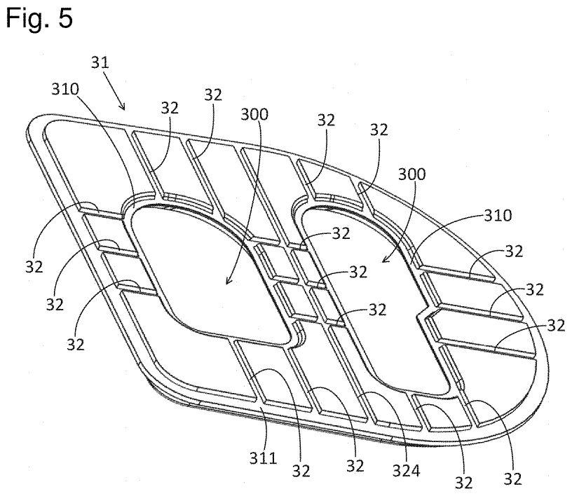

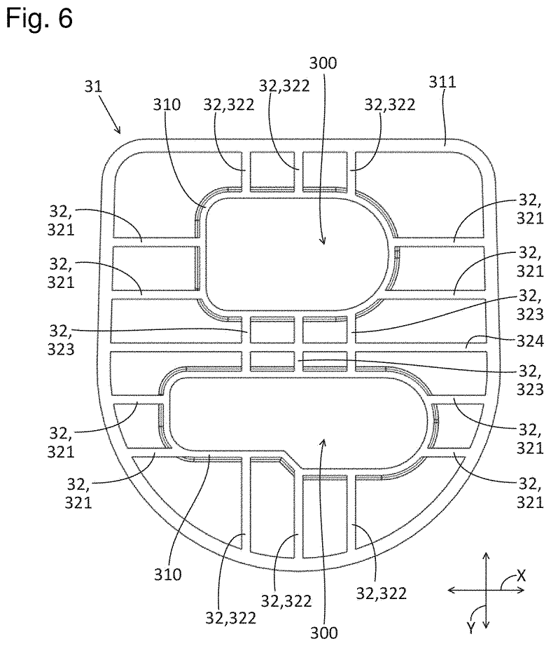

FIG. 5 is a perspective view of the cover 31 according to the example embodiment as viewed from above. FIG. 6 is a plan view of the cover 31 according to the example embodiment as viewed from above.

The obverse surface (the obverse surface on one side in the axial direction) of the cover 31 has a groove portion 32 recessed downward (to the other side in the axial direction). One end of the groove portion 32 communicates with the through-hole 300. In other words, the obverse surface of the cover 31 has the groove portion 32 communicating with the through-hole 300. In still other words, the obverse surface of the cover 31 has the groove portion 32 extending from the through-hole 300. For example, the groove portion 32 extends linearly.

Note that the connector portion 21 extends through the through-hole 300 from the lower side to the upper side of the cover 31. In this configuration, the groove portion 32 communicates between the inner edge of the through-hole 300 and the connector portion 21. In this case, a space between the inner edge of the through-hole 300 and the connector portion 21 is sealed with the seal 4. Accordingly, the groove portion 32 communicates with the seal 4 by sealing the space between the inner edge of the through-hole 300 and the connector portion 21 with the seal 4.

By providing the groove portion 32 on the obverse surface of the cover 31, water droplets attached to the seal 4 and its periphery flow through the groove portion 32. As a result, water droplets are less likely to retain in the seal 4 and its periphery, and deterioration of the seal 4 can be suppressed. That is, it is possible to suppress deterioration in sealing effect by the seal 4. This makes it possible to suppress moisture from intruding into the controller 2 covered with the cover 31 and suppress the malfunction of the motor 1.

For example, the width of the groove portion 32 is 1.0 mm or more and 3.0 mm or less. The depth of the groove portion 23 is 0.5 mm or more and 1.5 mm or less. As a result, water droplets easily flow in the groove portion 23.

The groove portion 32 extends from the through-hole 300 and reaches an outer edge portion 311 of the cover 31. In other words, one end of the groove portion 32 communicates with the through-hole 300, and the other end opposite to the one end of the groove portion 32 communicates with the outer edge portion 311. In other words, the groove portion 32 extends in a direction away from the through-hole 300. The outer edge portion 311 is an end portion of the cover 31 which is located on the radially outside.

When the groove portion 32 extending from the through-hole 300 reaches the outer edge portion 311, a water droplet of the seal 4 can be guided to the outer edge portion 311. That is, the water droplet of the seal 4 can be guided in a direction away from the seal 4. When the water droplet of the seal 4 is separated from the seal 4, it is possible to prevent the water droplet from adhering to the seal 4 again.

The outer edge portion 311 of the obverse surface of the cover 31 is recessed downward (to the other side in the axial direction) and is flush with the bottom surface of the groove portion 32. In other words, a portion of the obverse surface of the cover 31 which constitutes the bottom surface of the groove portion 32 is flush with the outer edge portion 311. In other words, there is no step at the boundary between the groove portion 32 and the outer edge portion 311. Accordingly, a flow path of water droplets extends from one end of the groove portion 32 which communicates with the through-hole 300 to the outer edge portion 311, but the flow path is flat and extends without unevenness.

Making the bottom surface of the groove portion 32 flush with the outer edge portion 311 makes it possible to prevent water droplets flowing through the groove portion 32 from being blocked by the outer edge portion 311. In other words, water droplets smoothly flow through the groove portion 32 toward the outer edge portion 311. This makes it difficult for water droplets to remain in the groove portion 32. As a result, it is possible to further suppress the water droplets in the groove portion 32 from adhering to the seal 4 again.

The obverse surface of the cover 31 has a plurality of groove portions 32. More specifically, the plurality of groove portions 32 respectively communicate with the plurality of through-holes 300. This increases the number of flow paths for causing water droplets attached to the seal 4 and its periphery to flow. As a result, it is possible to further suppress water droplets from retaining in the seal 4 and its periphery.

The plurality of groove portions 32 include a first groove portion 321 extending in the first direction and a second groove portion 322 extending in the second direction intersecting the first direction (see FIG. 6). Referring to FIG. 6, the first direction is the X direction, and the second direction is the Y direction. That is, the first groove portion 321 and the second groove portion 322 extend in directions orthogonal to each other. Both the first groove portion 321 and the second groove portion 322 communicate with each through-hole 300. The plurality of first groove portions 321 communicate with each of the through-holes 300, and the plurality of second groove portions 322 communicate with each of the through-holes.

One end of the first groove portion 321 communicates with the through-hole 300, and the other end of the first groove portion 321 communicates with the outer edge portion 311. Likewise, one end of the second groove portion 322 communicates with the through-hole 300, and the other end of the second groove portion 322 communicates with the outer edge portion 311.

Since the plurality of groove portions 32 include the first groove portion 321 and the second groove portion 322, a water droplet flows through any one of the groove portions 32 regardless of the assembling direction (that is, the direction of the cover 31) of the motor assembly 100. That is, regardless of the assembling direction of the motor assembly 100, it is possible to suppress water droplets from retaining in the seal 4 and its periphery.

For example, when the motor assembly 100 is assembled such that the second groove portion 322 extends in the vertical direction (see FIG. 6), water droplets can efficiently flow through the second groove portion 322. When the motor assembly 100 is assembled such that the first groove portion 321 extends in the vertical direction (not illustrated), water droplets can efficiently flow through the first groove portion 321.

In addition, the plurality of groove portions 32 include a communication groove portion 323 making one through-hole 300 communicate with the other through-hole 300. One end of the communication groove portion 323 communicates with one through-hole 300, and the other end of the communication groove portion 323 communicates with the other through-hole 300. More specifically, one end of the communication groove portion 323 communicates between the inner edge of one through-hole 300 and the connector portion 21, and the other end of the communication groove portion 323 communicates between the inner edge of the other through-hole 300 and the connector portion 21. The communication groove portion 323 extends linearly from one through-hole 300 toward the other through-hole. The number of communication groove portions 323 is plural.

For example, the motor assembly 100 is sometimes assembled such that one and the other through-holes 300 are aligned in the vertical direction, and the other through-hole 300 is sometimes disposed below the one through-hole 300. Note that water droplets flow from the top to the bottom.

In this example, when the communication groove portion 323 is not present, even if a water droplet adheres to the lower portion of the through-hole 300 located on the upper side and its periphery, the water droplet hardly flows. On the other hand, when the communication groove portion 323 is present, water droplets adhering to the lower portion of the through-hole 300 located on the upper side and its periphery can flow through the communication groove portion 323.

That is, in the configuration in which the plurality of groove portions 32 include the communication groove portions 323, even if there is the seal 4 in which water droplets are likely to retain in terms of position, the water droplets of the seal 4 flow through the communication groove portion 323. Accordingly, it is possible to further suppress water droplets from retaining in the seal 4 regardless of the assembling direction of the motor assembly 100.

The obverse surface of the cover 31 further includes an intermediate groove portion 324 located between the one through-hole 300 and the other through-hole 300 when viewed from the axial direction. Similarly to the groove portion 32, the intermediate groove portion 324 is recessed downward (to the other side in the axial direction) and extends linearly. The intermediate groove portion 324 crosses the communication groove portion 323 and reaches a portion on the other side opposite to the one side from a portion of the outer edge portion 311 which is located on one side. That is, one end of the intermediate groove portion 324 communicates with a portion of the outer edge portion 311 which is located on one side, and the other end of the intermediate groove portion 324 communicates with a portion of the outer edge portion 311 on the other side.

Providing the intermediate groove portion 324 crossing the communication groove portion 323 makes it possible to introduce a water droplet flowing through the communication groove portion 323 into the intermediate groove portion 324 and flow to the outer edge portion 311. This makes it possible to suppress water droplets from remaining in the communication groove portion 323.

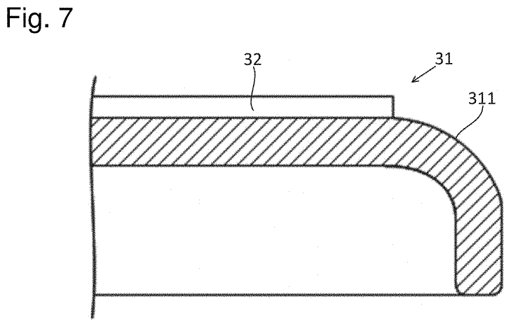

FIG. 7 is a cross-sectional view schematically illustrating the shape of the outer edge portion 311 of the cover 31 according to the first modification. FIG. 7 corresponds to a cross-section obtained by cutting a portion of the cover 31 where the groove portion 32 is formed along the extending direction of the groove portion 32. Referring to FIG. 7, a direction from the left to the right in the drawing corresponds to a direction from the through-hole 300 (not illustrated) to the outer edge portion 311.

In the first modification, similarly to the above example embodiment, a flow path of a water droplet is from one end of the groove portion 32 which communicates with the through-hole 300 to the outer edge portion 311. However, in the first modification, the flow path is not flat.

More specifically, at least a portion of the outer edge portion 311 which communicates with the groove portion 32 is inclined downward (to the other side in the axial direction) from the through-hole 300 toward the outer edge portion 311. For example, the outer edge portion 311 is inclined downward over the entire circumference regardless of whether or not the outer edge portion communicates with the groove portion 32. However, the present invention is not limited to this. Only a portion of the outer edge portion 311 which communicates with the groove portion 32 may be inclined downward.

In addition, for example, the outer edge portion 311 is inclined downward in a curved shape. In other words, the obverse surface of the outer edge portion 311 is a curved surface inclined downward. However, the present invention is not limited to this. Although not illustrated, the outer edge portion 311 may be inclined downward linearly. The outer edge portion 311 may be inclined downward stepwise.

In the configuration in which the outer edge portion 311 is inclined downward, a water droplet guided to the outer edge portion 311 easily drops from the outer edge portion 311. In other words, it is possible to prevent the water droplet guided to the outer edge portion 311 from being blocked by the outer edge portion 311. As a result, water droplets are less likely to remain in the groove portion 32, and thus it is possible to further suppress the water droplets in the groove portion 32 from adhering to the seal 4 again.

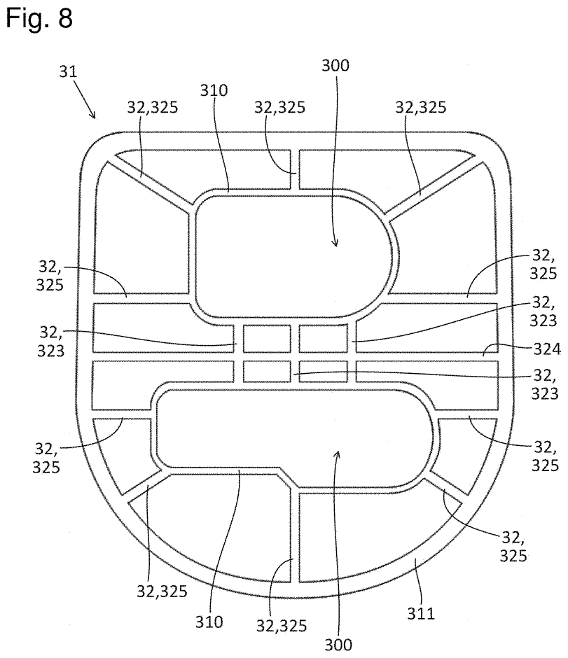

FIG. 8 is a plan view of the cover 31 according to a second modification as viewed from above.

In the second modification, the plurality of groove portions 32 include radial groove portions 325 radially extending from the through-holes 300. For example, the plurality of groove portions 32 include radial groove portions 325 in addition to the communication groove portions 323. The obverse surface of the cover 31 has the intermediate groove portion 324. That is, in the second modification, the obverse surface of the cover 31 has the radial groove portion 325 instead of the first groove portion 321 and the second groove portion 322.

The radial groove portion 325 communicates with each through-hole 300. That is, the radial groove portions 325 radially extend from the respective through-holes 300. One end of the radial groove portion 325 communicates with the through-hole 300, and the other end of the radial groove portion 325 communicates with the outer edge portion 311.

In the second modification, a water droplet flows through any one of the groove portions 32 regardless of the assembling direction (that is, the direction of the cover 31) of the motor assembly 100. That is, regardless of the assembling direction of the motor assembly 100, it is possible to further suppress water droplets from retaining in the seal 4 and its periphery.

The example embodiment of the present invention is described as above. Note that the scope of the present invention is not limited to the above-described example embodiment. The present invention can be implemented with various modifications within a scope not departing from the gist of the invention. Further, the above-described example embodiment can be appropriately and optionally combined.

The present invention can be applied to, for example, an electric power steering device used for assisting steering wheel operation of a vehicle such as an automobile.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor assembly comprising:
a motor including a rotor rotatable about a central axis and a stator radially opposing the rotor;
a controller to control the motor;
a housing to accommodate the motor and the controller; and
a seal; wherein
the housing includes a cover to cover the controller from one side in an axial direction;
the cover includes a through-hole penetrating in the axial direction;
the controller includes a connector portion extending through the through-hole and protruding to the one side in the axial direction of the cover;
the seal seals an area between an inner edge of the through-hole and the connector portion;
an obverse surface on the one side in the axial direction of the cover includes a groove portion recessed toward the other side in the axial direction; and
one end of the groove portion communicates with the through-hole.

2. The motor assembly according to claim 1, wherein the groove portion extends from the through-hole and reaches an outer edge portion of the cover.

3. The motor assembly according to claim 2, wherein the outer edge portion of the obverse surface is recessed to the other side in the axial direction and is flush with a bottom surface of the groove portion.

4. The motor assembly according to claim 2, wherein at least a portion communicating with the groove portion, of the outer edge portion, is inclined to the other side in the axial direction from the through-hole toward the outer edge portion.

5. The motor assembly according to claim 1, wherein the obverse surface includes a plurality of the groove portions.

6. The motor assembly according to claim 5, wherein the plurality of groove portions include a first groove portion extending in a first direction and a second groove portion extending in a second direction intersecting the first direction.

7. The motor assembly according to claim 5, wherein
the cover includes a plurality of the through-holes; and
the plurality of groove portions include a communication groove portion making one of the through-holes communicate with the other through-hole.

8. The motor assembly according to claim 5, wherein the plurality of groove portions include radial groove portions radially extending from the through-hole.

9. The motor assembly according to claim 1, wherein
the obverse surface includes a seal placement portion on an outer peripheral portion of the through-hole;
the seal placement portion is recessed to the other side in the axial direction; and
the seal extends between an inner edge of the through-hole and the connector portion from the seal placement portion.

10. The motor assembly according to claim 1, wherein
the housing includes a housing body that covers the motor and the controller from outside in a radial direction and includes an opening on the one side in the axial direction;
the cover closes the opening of the housing body from the one side in the axial direction;
an end portion on the one side in the axial direction of the housing body includes a recess recessed to the other side in the axial direction;
a reverse surface opposite to the obverse surface of the cover includes a protrusion protruding to the other side in the axial direction;
the protrusion is inside the recess; and
an adhesive is between the protrusion and the recess inside the recess.

11. The motor assembly according to claim 1, wherein a width of the groove portion is not less than about 1.0 mm and not more than about 3.0 mm.

12. The motor assembly according to claim 1, wherein a depth of the groove portion is not less than about 0.5 mm and not more than about 1.5 mm.
